(19) United States
(12) Patent Application Publication
(10) Pub. No.: US 2011/0293172 A1
(43) Pub. Date: Dec. 1, 2011

(54) IMAGE PROCESSING APPARATUS, IMAGE PROCESSING METHOD, AND IMAGE DISPLAY APPARATUS

(76) Inventors: Hirotaka SAKAMOTO, Tokyo (JP); Noritaka Okuda, Tokyo (JP); Satoshi Yamanaka, Tokyo (JP); Toshiaki Kubo, Tokyo (JP)

(21) Appl. No.: 13/117,190

(22) Filed: May 27, 2011

(30) Foreign Application Priority Data
May 28, 2010 (JP) 2010-122925

(51) Int. Cl. G06K 9/00

(52) U.S. Cl. 382/154

(57) ABSTRACT

An image processing apparatus 100 includes a parallax calculating unit 1. The parallax calculating unit 1 receives input of a pair of image input data Da1 and Db1 forming a three-dimensional video, calculates parallax amounts of respective regions obtained by dividing the pair of image input data Da1 and Db1 into a plurality of regions, and outputs the parallax amounts as parallax data T1 of the respective regions. The parallax calculating unit 1 includes a correlation calculating unit 10, a high-correlation-region extracting unit 11, a denseness detecting unit 12, and a parallax selecting unit 13. The correlation calculating unit 10 outputs correlation data T10 and pre-selection parallax data T13 of the respective regions. The high-correlation-region extracting unit 11 determines a level of correlation among the correlation data T10 of the regions and outputs high-correlation region data T11. The denseness detecting unit 12 determines, based on the high-correlation region data T11, a level of denseness and outputs dense region data T12. The parallax selecting unit 13 outputs, based on the dense region data T12, the parallax data T1 obtained by correcting the pre-selection parallax data T13.

### BACKGROUND OF THE INVENTION

1. Field of the Invention

The present invention relates to an image processing apparatus that generates a three-dimensional video using a pair of input images corresponding to a parallax between both the eyes, an image processing method, and an image display apparatus.

2. Description of the Related Art

In recent years, as an image display technology for a viewer to simulatively obtain the sense of depth, there is a three-dimensional image display technology that makes use of the binocular parallax. In the three-dimensional image display technology that makes use of the binocular parallax, a video viewed by the left eye and a video viewed by the right eye in a three-dimensional space are separately shown to the left eye and the right eye of the viewer, whereby the viewer feels that the videos are three-dimensional.

As a technology for showing different videos to the left and right eyes of the viewer, there are various systems such as a system for temporally alternately switching an image for left eye and an image for right eye to display the images on a display and, at the same time, temporally separating the left and right fields of view using eyeglasses for controlling amounts of light respectively transmitted through the left and right lenses in synchronization with image switching timing and a system for using, on the front surface of a display, a barrier and a lens for limiting a display angle of an image to show an image for left eye and an image for right eye respectively to the left and right eyes.

In such a three-dimensional image display apparatus, a viewer focuses the eyes on a display surface while adjusting the convergence angle of the eyes to the position of a projected object. When a projection amount is too large, this inconsistency induces the fatigue of the eyes for the viewer. On the other hand, the sense of depth that induces the fatigue of the eyes for the viewer is different depending on the distance between the viewer and the display surface of the display and individual differences of the viewer. The convergence angle represents an angle formed by the line of sight of the left eye and the line of sight of the right eye. The sense of depth represents a projection amount or a retraction amount of the object represented by the binocular parallax.

As measures against the problems, Japanese Patent Application Laid-Open No. 2008-306739 (page 3 and FIG. 5) discloses a technology for reducing the fatigue of the eyes of a viewer by changing the parallax of a three-dimensional image when it is determined based on information concerning a parallax embedded in a three-dimensional video that a display time of the three-dimensional image exceeds a predetermined time.

However, the parallax information is not embedded in some three-dimensional videos. Therefore, in the technology in the past, the parallax of the three-dimensional image cannot be changed when the parallax information is not embedded in the three-dimensional video. An amount for changing the parallax is determined without taking into account the distance between the viewer and a display surface and individual differences of the viewer. Therefore, a three-dimensional image having a suitable sense of depth, with which the eyes are less easily strained, corresponding to an individual viewer cannot be displayed.

Put another way, it is desired to, irrespective of whether parallax information is embedded in a three-dimensional video, change a parallax between an input pair of images to a parallax for a suitable sense of depth, with which the eyes are less easily strained compared with the conventional technology, corresponding to the distance between the viewer and the display surface and individual differences such as realistic sensation of the viewer to the three-dimensional video and display a three-dimensional image.

Moreover, when the parallax information is not embedded in the three-dimensional video, estimation of parallax is performed to extract the parallax information with high accuracy from an input image. In Japanese Patent Application Laid-Open No. 2004-007707 (paragraph 0011), it is disclosed to perform parallax estimation that changes discontinuously on an object contour. In the invention in Japanese Patent Application Laid-Open No. 2004-007707, an initial parallax and a reliability evaluation value of the initial parallax are calculated and a region in which reliability of the initial parallax is low is extracted from the reliability evaluation value. In the invention in Japanese Patent Application Laid-Open No. 2004-007707, the parallax in the extracted region in which reliability of the initial parallax is low is determined to be smoothly connected to the parallax therearound and change on an object contour.

However, in the conventional technology of estimating the parallax such as Japanese Patent Application Laid-Open No. 2004-007707, although the parallax information with a low reliability can be estimated and interpolated, the parallax information that is considered to be falsely detected cannot be removed from an input image and therefore the parallax information with a high estimation level cannot be extracted.

### SUMMARY OF THE INVENTION

It is an object of the present invention to at least partially solve the problems in the conventional technology.

An image processing apparatus according to an aspect of the present invention includes: a parallax calculating unit that receives input of a pair of images corresponding to a parallax between both eyes, divides the pair of images into a plurality of regions, calculates parallaxes in the respective regions, and outputs the parallaxes corresponding to the respective regions as a plurality of parallax data; a frame-parallax calculating unit that outputs maximum parallax data among the parallax data as frame parallax data; a frame-parallax correcting unit that outputs the frame parallax data of one frame as frame parallax data after correction corrected according to the frame parallax data of other frames; a parallax-adjustment-amount calculating unit that outputs, based on parallax adjustment information created according to an instruction of an observer and the frame parallax data after correction, parallax adjustment data; and an adjusted-image generating unit that generates a pair of images obtained by adjusting, based on the parallax adjustment data, a parallax between the pair of images.

Additionally, the parallax calculating unit includes: a correlation calculating unit that outputs, according to a phase limiting correlation method, correlation data and parallax data before selection of each of a plurality of regions obtained by dividing the pair of images; a high-correlation-region extracting unit that outputs, as high correlation region data, a result of determination concerning whether the correlation data of the regions is high or low; a denseness detecting unit that outputs, based on the high correlation region data, dense region data; and a parallax selecting unit that outputs, based on the dense region data and the parallax data before selection, the parallax data obtained by correcting the parallax data before selection of the regions.

An image display apparatus according to an aspect of the present invention includes: a parallax calculating unit that receives input of a pair of images corresponding to a parallax between both eyes, divides the pair of images into a plurality of regions, calculates parallaxes in the respective regions, and outputs the parallaxes corresponding to the respective regions as a plurality of parallax data; a frame-parallax calculating unit that outputs maximum parallax data among the parallax data as frame parallax data; a frame-parallax correcting unit that outputs the frame parallax data of one frame as frame parallax data after correction corrected according to the frame parallax data of other frames; a parallax-adjustment-amount calculating unit that outputs, based on parallax adjustment information created according to an instruction of an observer and the frame parallax data after correction, parallax adjustment data; an adjusted-image generating unit that generates a pair of images obtained by adjusting, based on the parallax adjustment data, a parallax between the pair of images; and a display unit that displays a pair of images generated by the adjusted-image generating unit of the image processing apparatus.

Additionally, the parallax calculating unit includes: a correlation calculating unit that outputs, according to a phase limiting correlation method, correlation data and parallax data before selection of each of a plurality of regions obtained by dividing the pair of images; a high-correlation-region extracting unit that outputs, as high correlation region data, a result of determination concerning whether the correlation data of the regions is high or low; a denseness detecting unit that outputs, based on the high correlation region data, dense region data; and a parallax selecting unit that outputs, based on the dense region data and the parallax data before selection, the parallax data obtained by correcting the parallax data before selection of the regions.

An image processing method according to an aspect of the present invention includes: receiving input of a pair of images corresponding to a parallax between both eyes, detecting a parallax between the pair of images, and outputting parallax data; aggregating the parallax data and outputting the parallax data as frame parallax data; outputting the frame parallax data of a relevant frame as frame parallax data after correction corrected according to the frame parallax data of frames other than the relevant frame; outputting, based on parallax adjustment information created according to an instruction of an observer and the frame parallax data after correction, parallax adjustment data; and generating a new pair of images obtained by adjusting, based on the parallax adjustment data, a parallax between the pair of images.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of the configuration of an image display apparatus according to a first embodiment of the present invention;

FIG. 2 is a diagram of the detailed configuration of a parallax calculating unit 1 of an image processing apparatus according to the first embodiment of the present invention;

FIGS. 3A to 3D are diagrams for explaining a method in which the parallax calculating unit 1 of the image processing apparatus according to the first embodiment of the present invention calculates, based on image input data for left eye Da1 and image input data for right eye Db1, parallax data T1;

FIG. 4 is a diagram of the detailed configuration of a correlation calculating unit 10 of the image processing apparatus according to the first embodiment of the present invention;

FIGS. 5A to 5C are diagrams for explaining a method in which the correlation calculating unit 10 of the image processing apparatus according to the first embodiment of the present invention calculates correlation data T10 and parallax data before selection T13;

FIG. 6 is a detailed diagram of the correlation data T10 input to a high-correlation-region detecting unit 11 of the image processing apparatus according to the first embodiment of the present invention and high correlation region data T11 output from the high-correlation-region detecting unit 11;

FIG. 7 is a diagram for explaining a method of calculating the high correlation region data T11 from the correlation data T10 of the image processing apparatus according to the first embodiment of the present invention;

FIG. 8 is a detailed diagram of the high correlation region data T11 input to a denseness detecting unit 12 of the image processing apparatus according to the first embodiment of the present invention and dense region data T12 output from the denseness detecting unit 12;

FIG. 9 is a diagram for explaining a method of calculating the dense region data T12 from the high correlation region data T11 of the image processing apparatus according to the first embodiment of the present invention;

FIG. 10 is a detailed diagram of the dense region data T12 input to a parallax selecting unit 13 of the image processing apparatus according to the first embodiment of the present invention and the parallax data T1 output from the parallax selecting unit 13;

FIGS. 11A and 11B are diagrams for explaining a method of calculating the parallax data T1 from the dense region data T12 and the parallax data before selection T13 of the image processing apparatus according to the first embodiment of the present invention;

FIG. 12 is a detailed diagram of the parallax data T1 input to a frame-parallax calculating unit 2 of the image processing apparatus according to the first embodiment of the present invention;

FIG. 13 is a diagram for explaining a method of calculating frame parallax data T2 from the parallax data T1 of the image processing apparatus according to the first embodiment of the present invention;

FIGS. 14A and 14B are diagrams for explaining in detail frame parallax data after correction T3 calculated from the frame parallax data T2 of the image processing apparatus according to the first embodiment of the present invention;

FIGS. 15A and 15B are diagrams for explaining a change in a projection amount due to a change in a parallax amount between image input data Da1 and Db1 and a parallax amount between image output data Da2 and Db2 of the image processing apparatus according to the first embodiment of the present invention;

FIG. 16 is a flowchart for explaining a flow of an image processing method according to a second embodiment of the present invention;

FIG. 17 is a flowchart for explaining a flow of a parallax calculating step ST1 of the image processing method according to the second embodiment of the present invention; and

FIG. 18 is a flowchart for explaining a flow of a frame-parallax correcting step ST3 of the image processing method according to the second embodiment of the present invention.

### DETAILED DESCRIPTION OF THE PREFERRED EMBODIMENTS

### First Embodiment

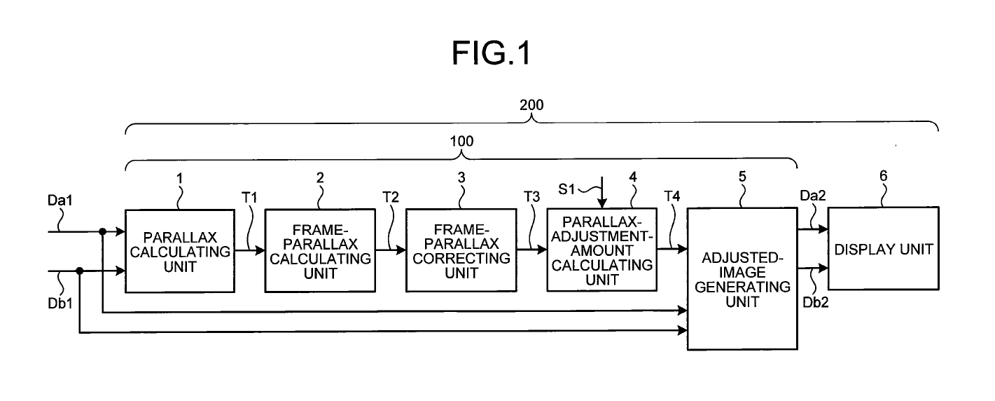

FIG. 1 is a diagram of the configuration of an image display apparatus 200 that displays a three-dimensional image according to a first embodiment of the present invention. The image display apparatus 200 according to the first embodiment includes a parallax calculating unit 1, a frame-parallax calculating unit 2, a frame-parallax correcting unit 3, a parallax-adjustment-amount calculating unit 4, an adjusted-image generating unit 5, and a display unit 6. An image processing apparatus 100 in the image display apparatus 200 includes the parallax calculating unit 1, the frame-parallax calculating unit 2, the frame-parallax correcting unit 3, the parallax-adjustment-amount calculating unit 4, and the adjusted-image generating unit 5.

Image input data for left eye Da1 and image input data for right eye Db1 are input to the parallax calculating unit 1 and the adjusted-image generating unit 5. The parallax calculating unit 1 calculates, based on the image input data for left eye Da1 and the image input data for right eye Db1, a parallax amount in each of regions and outputs parallax data T1. The parallax data T1 is input to the frame-parallax calculating unit 2.

The frame-parallax calculating unit 2 calculates, based on the parallax data T1, a parallax amount for a frame of attention and outputs the parallax amount as frame parallax data T2. The frame parallax data T2 is input to the frame-parallax correcting unit 3.

After correcting the frame parallax data T2 of the frame of attention referring to the frame parallax data T2 of frames at other hours, the frame-parallax correcting unit 3 outputs frame parallax data after correction T3. The frame parallax data after correction T3 is input to the parallax-adjustment-amount calculating unit 4.

The parallax-adjustment-amount calculating unit 4 outputs parallax adjustment data T4 calculated based on parallax adjustment information S1 input by a viewer and the frame parallax data after correction T3. The parallax adjustment data T4 is input to the adjusted-image generating unit 5.

The adjusted-image generating unit 5 outputs image output data for left eye Da2 and image output data for right eye Db2 obtained by adjusting, based on the parallax adjustment data T4, a parallax amount between the image input data for left eye Da1 and the image input data for right eye Db1. The image output data for left eye Da2 and the image output data for right eye Db2 are input to the display unit 6. The display unit 6 displays the image output data for left eye Da2 and the image output data for right eye Db2 on a display surface.

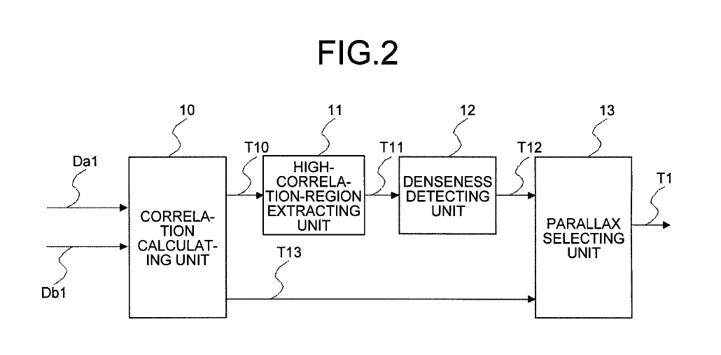

FIG. 2 is a diagram of the detailed configuration of the parallax calculating unit 1. The parallax calculating unit 1 includes a correlation calculating unit 10, a high-correlation-region extracting unit 11, a denseness detecting unit 12, and a parallax selecting unit 13.

The image input data for left eye Da1 and the image input data for right eye Db1 are input to the correlation calculating unit 10. The correlation calculating unit 10 calculates, based on the image input data for left eye Da1 and the image input data for right eye Db1, a correlation value and a parallax in each of the regions, outputs the correlation value as correlation data T10, and outputs the parallax as parallax data before selection T13. The correlation data T10 is input to the high-correlation-region extracting unit 11. The parallax data before selection T13 is input to the parallax selecting unit 13.

The high-correlation-region extracting unit 11 determines, based on the correlation data T10, whether correlation values of the regions are high or low and outputs a result of the determination as high correlation region data T11. The high correlation region data T11 is input to the denseness detecting unit 12.

The denseness detecting unit 12 determines, based on the high correlation region data T11, whether a high correlation region having a high correlation value is a region in which a plurality of high correlation regions are densely located close to one another. The denseness detecting unit 12 outputs a result of the determination as dense region data T12. The dense region data T12 is input to the parallax selecting unit 13.

The parallax selecting unit 13 outputs, based on the dense region data T12 and the parallax data before selection T13, concerning the dense high correlation region, a smoothed parallax as the parallax data T1 and outputs, concerning the other regions, an invalid signal as the parallax data T1.

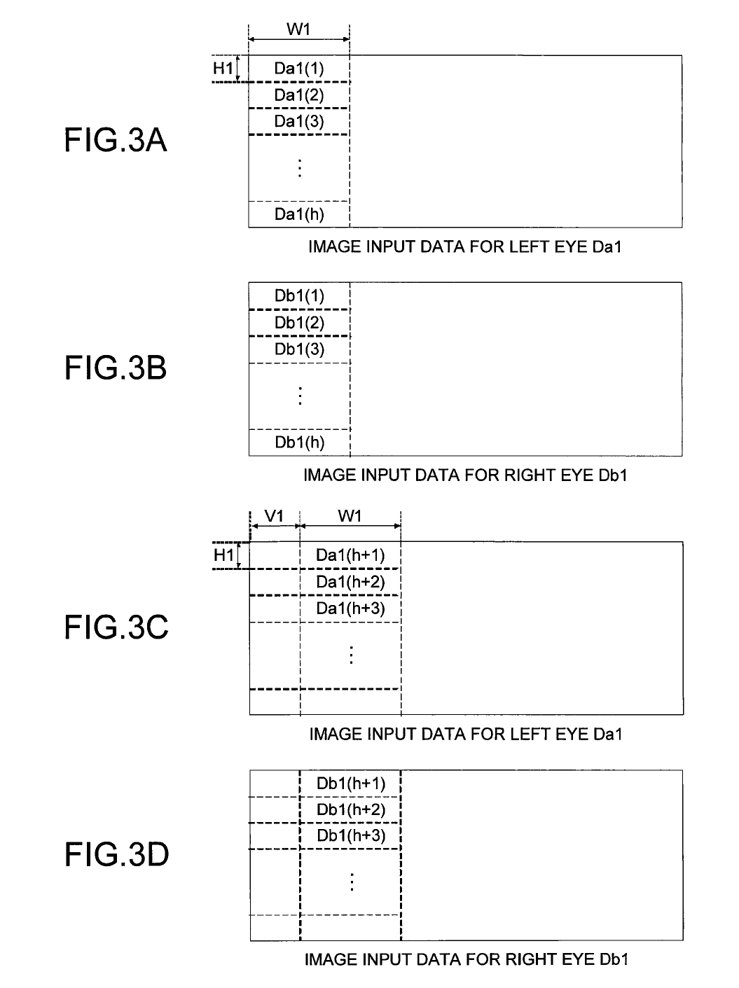

The detailed operation of the image processing apparatus 100 according to the first embodiment of the present invention is explained below. FIGS. 3A to 3D are diagrams for explaining a method in which the parallax calculating unit 1 calculates, based on the image input data for left eye Da1 and the image input data for right eye Db1, the parallax data T1.

The parallax calculating unit 1 divides the image input data for left eye Da1 and the image input data for right eye Db1, which are input data, in the size of regions sectioned in width W1 and height H1 and calculates a parallax in each of the regions. The regions that section the image input data for left eye Da1 and the image input data for right eye Db1 are shifted by width V1 (V1 is an integer equal to or smaller than W1) from one another in the horizontal direction and caused to overlap. A three-dimensional video is a moving image formed by continuous pairs of images for left eye and images for right eye. The image input data for left eye Da1 is an image for left eye and the image input data for right eye Db1 is an image for right eye. Therefore, the images themselves of the video are the image input data for left eye Da1 and the image input data for right eye Db1. For example, when the image processing apparatus according to the first embodiment is applied to a television, a decoder decodes a broadcast signal. A video signal obtained by the decoding is input as the image input data for left eye Da1 and the image input data for right eye Db1. As the width W1 and the height H1 of the regions that section a screen and the shifting width V1 in causing the regions to overlap, arbitrary values can be used. The width W1, the height H1, and the width V1 are determined, when the image processing apparatus according to the first embodiment is implemented in an actual LSI or the like, taking into account a processing amount or the like of the LSI.

Because the regions are caused to overlap in this way, regions obtained by slicing image input data in positions where a parallax can be easily detected increases and the accuracy of calculation of a parallax can be improved.

The number of regions in the vertical direction that section the image input data for left eye Da1 and the image input data for right eye Db1 is represented as a positive integer h and the number of sectioned regions is represented as a positive integer x. First, in FIGS. 3A and 3B, a number of a region at the most upper left is 1 and regions shifted by H1 from one another in the vertical direction are sequentially numbered 2 and 3 to h. In FIGS. 3C and 3D, a region shifted to the right by V1 from the first region is an h+1-th region. Subsequent regions are sequentially numbered in such a manner that a region shifted to the right by V1 from the second region is represented as an h+2-th region and a region shifted to the right by V1 from the h-th region is represented as a 2×h-th region. Similarly, the screen is sequentially sectioned into regions shifted to the left by V1 from one another to the right end of a display screen. A region at the most lower right is represented as an xth region.

Image input data included in the first region of the image input data for left eye Da1 is represented as Da1(1) and image input data included in the subsequent regions are represented as Db1(2) and Da1(3) to Da1(x). Similarly, image input data included in the regions of the image input data for right eye Db1 are represented as Db1(1), Db1(2), and Db1(3) to Db(x).

In the example explained above, the regions that section the image input data for left eye Da1 and the image input data for right eye Db1 are caused to overlap in the horizontal direction at equal intervals. However, the regions that section the image input data for left eye Da1 and the image input data for right eye Db1 can be caused to overlap in the vertical direction. Alternatively, the regions can be caused to overlap in the horizontal direction and the vertical direction. The regions do not have to be caused to overlap at equal intervals.

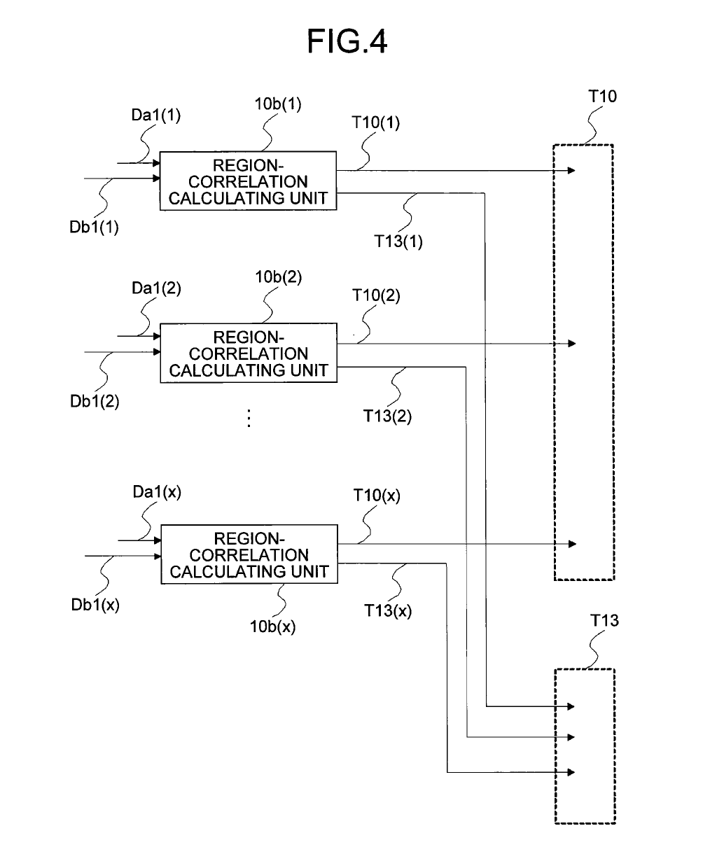

FIG. 4 is a diagram of the detailed configuration of the correlation calculating unit 10. The correlation calculating unit 10 includes x region-correlation calculating units to calculate a correlation value and a parallax in each of the regions. A region-correlation calculating unit 10b(1) calculates, based on the image input data for left eye Da1(1) and the image input data for right eye Db1(1) included in the first region, a correlation value and a parallax in the first region. The region-correlation calculating unit 10b(1) outputs the correlation value as correlation data T10(1) of the first region and outputs the parallax as parallax data before selection T13(1) of the first region. Similarly, a region-correlation calculating unit 10b(2) to a region-correlation calculating unit 10b(x) respectively calculate correlation values and parallaxes in the second to xth regions, output the correlation values as correlation data T10(2) to correlation data T10(x) of the second to xth regions, and output the parallaxes as parallax data before selection T13(2) to parallax data before selection T13(x) of the second to xth regions. The correlation calculating unit 10 outputs the correlation data T10(1) to the correlation data T10(x) of the first to xth regions as the correlation data T10 and outputs the parallax data before selection T13(1) to the parallax data before selection T13(x) of the first to xth regions as the parallax data before selection T13.

The region-parallax calculating unit 10b(1) calculates, using a phase limiting correlation method, the correlation data T10(1) and the parallax data before selection T13(1) between the image input data for left eye Da1(1) and the image input data for right eye Db1(1). The phase limiting correlation method is explained in, for example, Non-Patent Literature (Mizuki Hagiwara and Masayuki Kawamata “Misregistration Detection at Sub-pixel Accuracy of Images Using a Phase Limiting Function”, the Institute of Electronics, Information and Communication Engineers Technical Research Report, No. CAS2001-11, VLD2001-28, DSP2001-30, June 2001, pp. 79 to 86). The phase limiting correlation method is an algorithm for receiving a pair of images of a three-dimensional video as an input and outputting a parallax amount.

The following Formula (1) is a formula representing a parallax amount Nₒₚₜ calculated by the phase limiting correlation method. In Formula (1), Gab(n) represents a phase limiting correlation function.

Nₒₚₜ=arg max(G_{ab}(n)) (1)

where, n:0≦n≦W1 and arg max(G_{ab}(n)) is a value of n at which G_{ab}(n) is the maximum. When G_{ab}(n) is the maximum, n is Nₒₚₜ. Gab(n) is represented by the following Formula (2):

$${G}_{ab} ( n ) = IFFT ( \frac{{F}_{ab} ( n )}{\vert {F}_{ab} ( n ) \vert} ) \qquad ( 2 )$$

where, a function IFFT is an inverse fast Fourier transform function and |F_{ab}(n)| is the magnitude of F_{ab}(n). F_{ab}(n) is represented by the following Formula (3):

F_{ab}(n)=A·B*(n) (3)

where, B*(n) represents a sequence of a complex conjugate of B(n) and A·B*(n) represents a convolution of A and B*(n). A and B(n) are represented by the following Formula (4):

A=FFT(a(m)) B(n)=FFT(b(m−n)) (4)

where, a function FFT is a fast Fourier transform function, a(m) and b(m) represent continuous one-dimensional sequences, m represents an index of a sequence, b(m)=a(m−τ), i.e., b(m) is a sequence obtained by shifting a(m) to the right by τ, and b(m−n) is a sequence obtained by shifting b(m) to the right by n.

In the region-parallax calculating unit 1b, a maximum of G_{ab}(n) calculated by the phase limiting correlation method with the image input data for left eye Da1(1) set as “a” of Formula (4) and the image input data for right eye Db1(1) set as “b” of Formula (4) is the correlation data T10(1). The value Nₒₚₜ of n at which G_{ab}(n) is the maximum is the parallax data before selection T13(1).

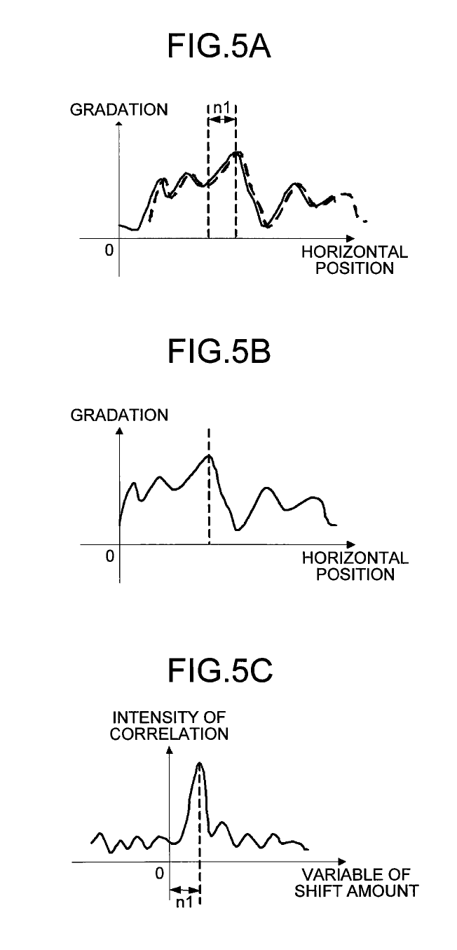

FIGS. 5A to 5C are diagrams for explaining a method of calculating the correlation data T10(1) and the parallax data before selection T13(1) from the image input data for left eye Da1(1) and the image input data for right eye Db1(1) included in the first region using the phase limiting correlation method. A graph represented by a solid line of FIG. 5A is the image input data for left eye Da1(1) corresponding to the first region. The abscissa indicates a horizontal position and the ordinate indicates a gradation. A graph of FIG. 5B is the image input data for right eye Db1(1) corresponding to the first region. The abscissa indicates a horizontal position and the ordinate indicates a gradation. A graph represented by a broken line of FIG. 5A is the image input data for right eye Db1(1) shifted by a parallax amount n1 of the first region. A graph of FIG. 5C is the phase limiting correlation function G_{ab}(n). The abscissa indicates a variable n of G_{ab}(n) and the ordinate indicates the intensity of correlation.

The phase limiting correlation function G_{ab}(n) is defined by a sequence “a” and a sequence “b” obtained by shifting “a” by τ, which are continuous sequences. The phase limiting correlation function G_{ab}(n) is a delta function having a peak at n=−τ according to Formulas (2) and (3). When the image input data for right eye Db1(1) projects with respect to the image input data for left eye Da1(1), the image input data for right eye Db1(1) shifts in the left direction. When the image input data for right eye Db1(1) retracts with respect to the image input data for left eye Da1(1), the image input data for right eye Db1(1) shifts in the right direction. Data obtained by dividing the image input data for left eye Da1(1) and the image input data for right eye Db1(1) into regions is highly likely to shift in one of the projecting direction and the retracting direction. Nₒₚₜ of Formula (1) calculated with the image input data for left eye Da1(1) and the image input data for right eye Db1(1) set as the inputs a(m) and b(m) of Formula (4) is the parallax data before selection T13(1). A maximum of the phase limiting correlation function G_{ab}(n) is the correlation data T10(1).

A shift amount is n1 according to a relation between FIGS. 5A and 5B. Therefore, when the variable n of a shift amount concerning the phase limiting correlation function G_{ab}(n) is n1 as shown in FIG. 5C, a value of a correlation function is the largest.

The region-correlation calculating unit 10b(1) shown in FIG. 4 outputs, as the correlation data T10(1), a maximum of the phase limiting correlation function G_{ab}(n) with respect to the image input data for left eye Da1(1) and the image input data for right eye Db1(1) according to Formula (1). The region-correlation calculating unit 10b(1) outputs, as the parallax data before selection T13(1), a shift amount n1 at which a value of the phase limiting correlation function G_{ab}(n) is the maximum. The parallax data before selection T13(1) to the parallax data before selection T13(x) are the parallax data before selection T13.

Similarly, the region-correlation calculating unit 10b(2) to the region-correlation calculating unit 10b(x) output, as the correlation data T10(2) to the correlation data T10(x), maximums of phase limiting correlations between the image input data for left eye Da1(2) to the image input data for left eye Da1(x) and the image input data for right eye Db1(2) to image input data for right eye Db1(x) included in the second to xth regions. The region-correlation calculating unit 10b(2) to the region-correlation calculating unit 10b(x) output, as the parallax data before selection T13(2) to the parallax data before selection T13(x), shift amounts at which values of the phase limiting correlations are the maximum.

Non-Patent Literature 1 describes a method of directly receiving the image input data for left eye Da1 and the image input data for right eye Db1 as inputs and obtaining a parallax between the image input data for left eye Da1 and the image input data for right eye Db1. However, as an input image is larger, computational complexity increases. When the method is implemented in an LSI, a circuit size is large. Further, the peak of the phase limiting correlation function G_{ab}(n) with respect to an object captured small in the image input data for left eye Da1 and the image input data for right eye Db1 is small. Therefore, it is difficult to calculate a parallax of the object captured small.

The parallax calculating unit 1 of the image processing apparatus according to the first embodiment divides the image input data for left eye Da1 and the image input data for right eye Db1 into small regions and applies the phase limiting correlation method to each of the regions. Therefore, the phase limiting correlation method can be implemented in an LSI in a small circuit size. In this case, the circuit size can be further reduced by calculating parallaxes for the respective regions in order using one circuit rather than simultaneously calculating parallaxes for all the regions. In the divided small regions, the object captured small in the image input data for left eye Da1 and the image input data for right eye Db1 occupies a relatively large area. Therefore, the peak of the phase limiting correlation function G_{ab}(n) is large and can be easily detected. Therefore, a parallax can be calculated more accurately.

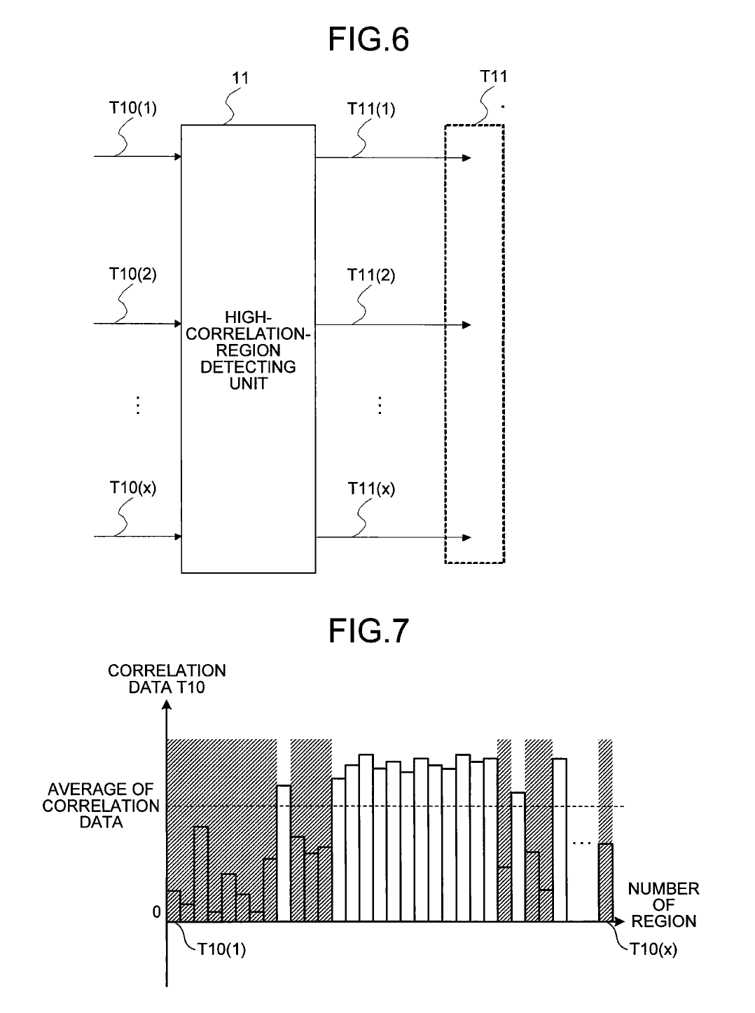

FIG. 6 is a detailed diagram of the correlation data T10 input to the high-correlation-region detecting unit 11 and the high correlation region data T11 output from the high-correlation-region detecting unit 11. The high-correlation-region detecting unit 11 determines whether the input correlation data T10(1) to correlation data T10(x) corresponding to the first to xth regions are high or low. The high-correlation-region detecting unit 11 outputs a result of the determination as high correlation region data T11(1) to high correlation region data T11(x) corresponding to the first to xth regions. The high correlation region data T11(1) to the high correlation region data T11(x) are the high correlation region data T11.

FIG. 7 is a diagram for explaining a method of calculating, based on the correlation data T10(1) to the correlation data T10(x), the high correlation region data T11(1) to the high correlation region data T11(x). The abscissa indicates a region number and the ordinate indicates correlation data. The high-correlation-region detecting unit 11 calculates an average of the correlation data T10(1) to the correlation data T10(x), determines whether the correlation data T10(1) to the correlation data T10(x) are higher or lower than the average, and calculates a result of the determination as the high correlation region data T11(1) to the high correlation region data T11(x). Correlation data is low in hatching masked regions and correlation data in the other regions is high in FIG. 7. The regions determined as having the high correlation data are referred to as high correlation regions. Consequently, it is possible to detect regions in which correlation is high and parallaxes are correctly calculated and improve accuracy of calculation of parallaxes.

In the example explained above, the determination is performed with reference to the average of the correlation data T10(1) to the correlation data T10(x). However, a constant set in advance can be used as the reference for determining whether the correlation data T10(1) to the correlation data T10(x) are high or low.

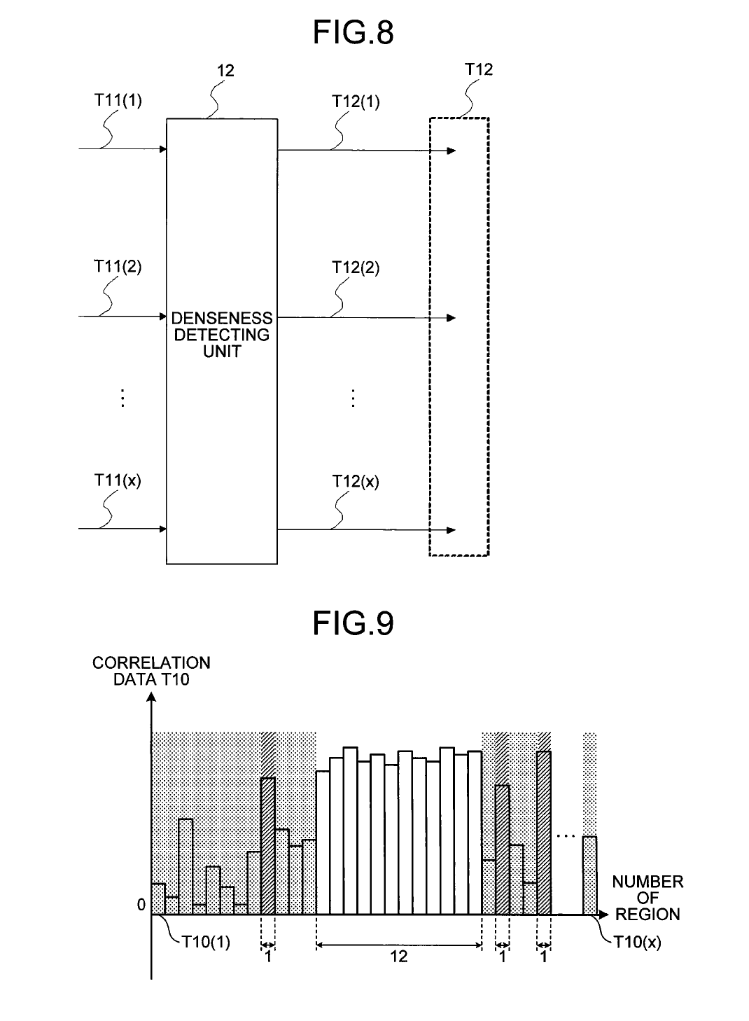

FIG. 8 is a detailed diagram of the high correlation region data T11 input to the denseness detecting unit 12 and the dense region data T12 output from the denseness detecting unit 12. The denseness detecting unit 12 determines, based on the input high correlation region data T11(1) to high correlation region data T11(x) corresponding to the first to xth regions, whether a high correlation region is a region in which a plurality of high correlation regions are densely located close to one another. The denseness detecting unit 12 outputs a result of the determination as dense region data T12(1) to dense region data T12(x) corresponding to the first to xth regions. The dense region data T12(1) to the dense region data T12(x) are the dense region data T12.

FIG. 9 is a diagram for explaining a method of calculating, based on the high correlation region data T11(1) to the high correlation region data T11(x), the dense region data T12(1) to the dense region data T12(x). The abscissa indicates a region number and the ordinate indicates correlation data. The denseness detecting unit 12 determines, based on the high correlation region data T11(1) to the high correlation region data T11(x), high correlation regions that are positionally continuous by a fixed number or more and calculates a result of the determination as the dense region data T12(1) to the dense region data T12(x). However, a c×h-th (c is an integer equal to or larger than 0) high correlation region and a c×h+1-th high correlation region are not continuous on image input data. Therefore, when it is determined whether high correlation regions are continuous, it is not determined that the high correlation regions are continuous across the c×h-th and c×h+1-th regions. In FIG. 9, a region in which twelve or more high correlation regions are continuous is determined as dense. Regions determined as having low correlation are indicated by a gray mask and regions that are high correlation regions but are not dense are indicated by a hatching mask. The remaining non-masked regions indicate dense high correlation regions. Consequently, it is possible to detect a region where a parallax can be easily detected and improve accuracy of calculation of a parallax by selecting a parallax in the region where a parallax can be easily detected.

As a reference for determining that a region is dense, besides a reference concerning whether high correlation regions are continuous in the vertical direction, a reference concerning whether high correlation regions are continuous in the horizontal direction can be adopted. A reference concerning whether high correlation regions are continuous in both the vertical direction and the horizontal direction can also be adopted. Further, the density of high correlation regions in a fixed range can be set as a reference instead of determining whether high correlation regions are continuous.

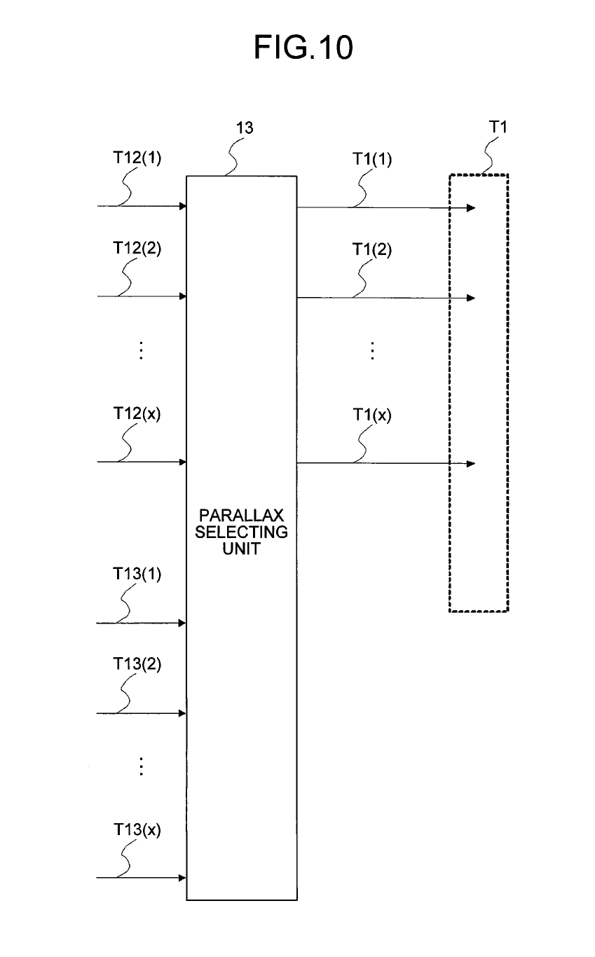

FIG. 10 is a detailed diagram of the dense region data T12 and the parallax data before selection T13 input to the parallax selecting unit 13 and the parallax data T1 output from the parallax selecting unit 13. The parallax selecting unit 13 outputs, based on the input dense region data T12(1) to dense region data T12(x) and parallax data before selection T13(1) to parallax data before selection T13(x) corresponding to the first to xth regions, as the parallax data T1(1) to parallax data T1(x), values obtained by smoothing the parallax data before selection T13(1) to the parallax data before selection T13(x) in the dense high correlation regions. Concerning the regions other than the dense high correlation regions, the parallax selecting unit 13 outputs, as the parallax data before selection T13(1) to the parallax data before selection T13(x), an invalid signal representing that a parallax is not selected. The parallax data T1(1) to the parallax data T1(x) are the parallax data T1.

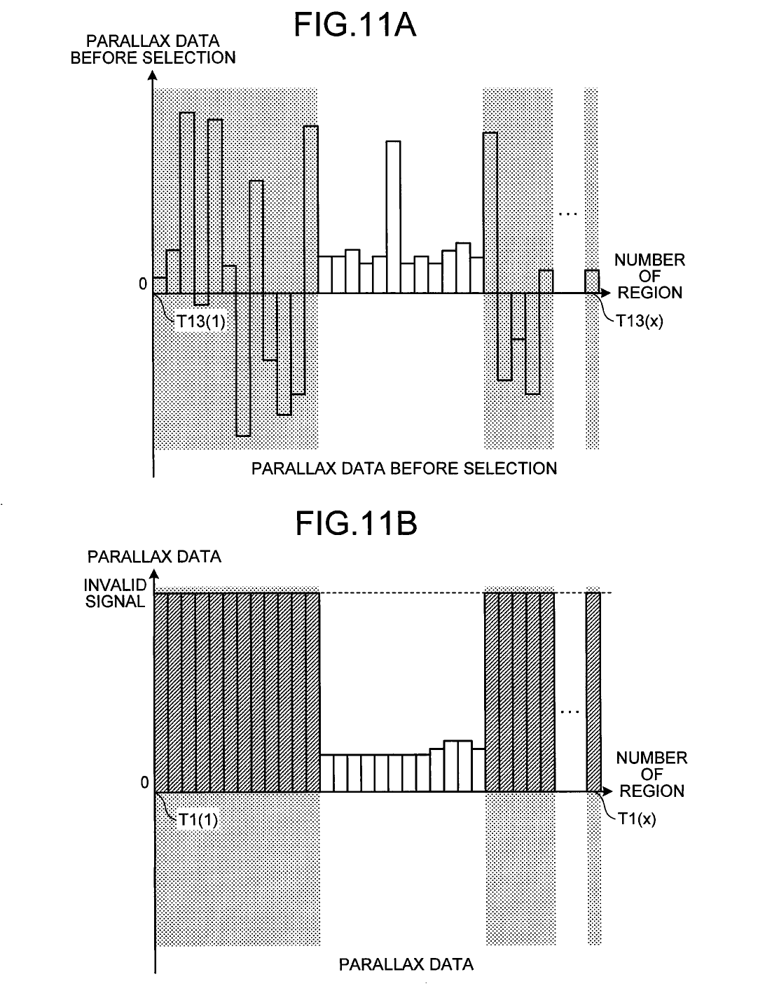

FIGS. 11A and 11B are diagrams for explaining a method of calculating, based on the dense region data T12(1) to the dense region data T12(x) and the parallax data before selection T13(1) to the parallax data before selection T13(x), the parallax data T1(1) to the parallax data T1(x). The abscissa indicates a region number and the ordinate indicates the parallax data before selection T13. The parallax selecting unit 13 outputs, based on the dense region data T12(1) to the dense region data T12(x) and the parallax data before selection T13(1) to the parallax data before selection T13(x), as the parallax data T1(1) to the parallax data T1(x), the parallax data before selection T13(1) to the parallax data before selection T13(x). Concerning the regions other than the dense high correlation regions, the parallax selecting unit 13 outputs, as the parallax data T1(1) to the parallax data T1(x), an invalid signal representing that a parallax is not selected. The parallax data T1(1) to the parallax data T1(x) are the parallax data T1. In FIGS. 11A and 11B, the regions other than the dense high correlation regions are indicated by a gray mask. FIG. 11A is a diagram of the parallax data before selection T13. FIG. 11B is a diagram of the parallax data T1. Consequently, it is possible to exclude failure values considered to be misdetections among parallaxes in the dense high correlation regions, which are regions in which parallaxes can be easily detected, and improve accuracy of calculation of a parallax.

The detailed operations of the frame-parallax calculating unit 2 are explained below.

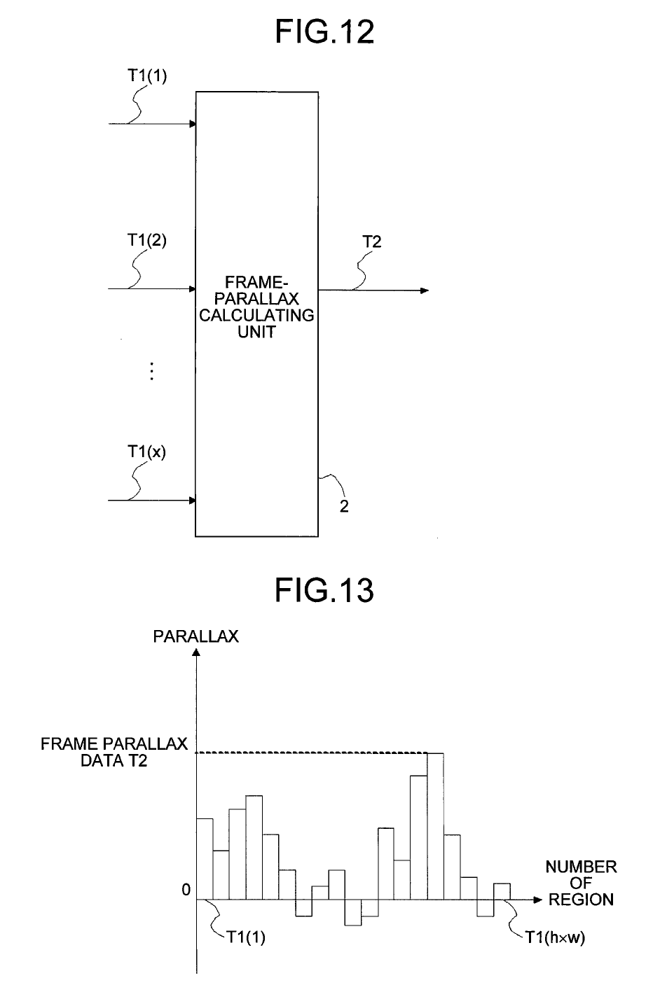

FIG. 12 is a detailed diagram of the parallax data T1 input to the frame-parallax calculating unit 2. The frame-parallax calculating unit 2 aggregates parallax data other than an invalid signal, which represents that a parallax is not selected, among the input parallax data T1(1) to parallax data T1(x) corresponding to the first to xth regions and calculates one frame parallax data T2 with respect to an image of a frame of attention.

FIG. 13 is a diagram for explaining a method of calculating, based on the parallax data T1(1) to the parallax data T1(x), the frame parallax data T2. The abscissa indicates a number of a region and the ordinate indicates parallax data. The frame-parallax calculating unit 2 outputs maximum parallax data among the parallax data T1(1) to the parallax data T1(x) as the frame parallax data T2 of a frame image.

Consequently, concerning a three-dimensional video not embedded with parallax information, it is possible to calculate a parallax amount in a section projected most in frames of the three-dimensional video considered to have the largest influence on a viewer.

The detailed operations of the frame-parallax correcting unit 3 are explained below.

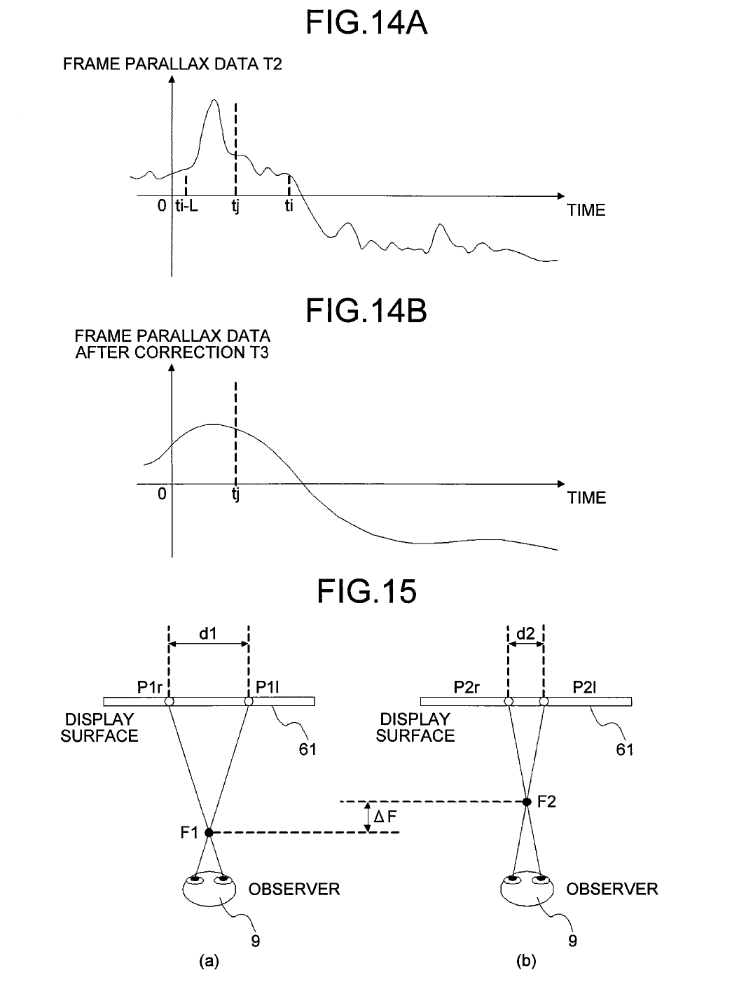

FIGS. 14A and 14B are diagrams for explaining in detail frame parallax data after correction T3 calculated from the frame parallax data T2. FIG. 14A is a diagram of a temporal change of the frame parallax data T2. The abscissa indicates time and the ordinate indicates the frame parallax data T2. FIG. 14B is a diagram of a temporal change of the frame parallax data after correction T3. The abscissa indicates time and the ordinate indicates the frame parallax data after correction T3.

The frame-parallax correcting unit 3 stores the frame parallax data T2 for a fixed time, calculates an average of a plurality of the frame parallax data T2 before and after a frame of attention, and outputs the average as the frame parallax data after correction T3. The frame parallax data after correction T3 is represented by the following Formula (5):

$$T3 ( tj ) = \frac{{\sum }_{k = ti - L}^{ti} T2 ( k )}{L} \qquad ( 5 )$$

where, T3(tj) represents frame parallax data after correction at an hour tj of attention, T2(k) represents frame parallax data at an hour k, and a positive integer L represents width for calculating an average. Because ti<tj, for example, the frame parallax data after correction T3 at the hour tj shown in FIG. 14B is calculated from an average of the frame parallax data T2 from an hour (ti−L) to an hour ti shown in FIG. 14A.

Most 3D projection amounts temporally continuously change. When the frame parallax data T2 temporally discontinuously changes, for example, when the frame parallax data T2 changes in an impulse shape with respect to a time axis, it can be regarded that misdetection of the frame parallax data T2 occurs. Because the frame-parallax correcting unit 3 temporally averages the frame parallax data T2 even if there is the change in the impulse shape, the frame-parallax correcting unit 3 can ease the misdetection.

The detailed operations of the parallax-adjustment-amount calculating unit 4 are explained below.

The parallax-adjustment-amount calculating unit 4 calculates, based on parallax adjustment information S1 set by a viewer 9 according to preference or a degree of fatigue and the frame parallax data after correction T3, a parallax adjustment amount and outputs parallax adjustment data T4.

The parallax adjustment information S1 includes a parallax adjustment coefficient S1a and a parallax adjustment threshold S1b. The parallax adjustment data T4 is represented by the following Formula (6):

$$T4 = \{ \begin{matrix}0 & ( T 3 \leq S 1 b ) \\ S 1 a \times ( T 3 - S 1 b ) & ( T 3 > S 1 b )\end{matrix} \qquad ( 6 )$$

The parallax adjustment data T4 means a parallax amount for reducing a projection amount according to image adjustment. The parallax adjustment data T4 indicates amounts for horizontally shifting the image input data for left eye Da1 and the image input data for right eye Db1. As explained in detail later, a sum of the amounts for horizontally shifting the image input data for left eye Da1 and the image input data for right eye Db1 is T4. Therefore, when the frame parallax data T3 is equal to or smaller than the parallax adjustment threshold S1b, the image input data for left eye Da1 and the image input data for right eye Db1 are not shifted in the horizontal direction according to the image adjustment. On the other hand, when the frame parallax data T3 is larger than the parallax adjustment threshold S1b, the image input data for left eye Da1 and the image input data for right eye Db1 are shifted in the horizontal direction by a value obtained by multiplying a value of a difference between the frame parallax data after correction T3 and the parallax adjustment threshold S1b with the parallax adjustment coefficient S1a.

For example, in the case of the parallax adjustment coefficient S1a=1 and the parallax adjustment threshold S1b=0, T4=0 when T3≦0. In other words, the image adjustment is not performed. On the other hand, T4=T3 when T3>0. The image input data for left eye Da1 and the image input data for right eye Db1 are shifted in the horizontal direction by T3. Because the frame parallax data after correction T3 is a maximum parallax of a frame image, a maximum parallax calculated in a frame of attention is 0. When the parallax adjustment coefficient S1a is reduced to be smaller than 1, the parallax adjustment data T4 decreases to be smaller than the frame parallax data after correction T3 and the maximum parallax calculated in the frame of attention increases to be larger than 0. When the parallax adjustment threshold S1b is increased to be larger than 0, adjustment of parallax data is not applied to the frame parallax data after correction T3 having a value larger than 0. In other words, parallax adjustment is not applied to a frame in which an image is slightly projected.

For example, a user determines the setting of the parallax adjustment information S1 while changing the parallax adjustment information S1 with input means such as a remote controller and checking a change in a projection amount of the three-dimensional image. The user can also input the parallax adjustment information S1 from a parallax adjustment coefficient button and a parallax adjustment threshold button of the remote controller. However, the predetermined parallax adjustment coefficient S1a and the parallax adjustment thresholds S1b can be set when the user inputs an adjustment degree of a parallax from one ranked parallax adjustment button.

Moreover, the image display apparatus 200 can include a camera or the like to observe the viewer 9 and determine the age of the viewer 9, the gender of the viewer 9, the distance from the display surface to the viewer 9, and the like to automatically set the parallax adjustment information S1. Furthermore, it is possible to include the size of the display surface of the image display apparatus 200 or the like in the parallax adjustment information S1. Moreover, only a predetermined value of the size of the display surface of the image display apparatus 200 or the like can be set as the parallax adjustment information S1. As above, information that includes information relating to the state of viewing such as personal information input by the viewer 9 by using an input unit such as a remote controller, the age of the viewer 9, the gender of the viewer 9, the positional relationship including the distance between the viewer 9 and the image display apparatus, and the size of the display surface of the image display apparatus is called information indicating the state of viewing.

Consequently, according to this embodiment, it is possible to change a parallax between an input pair of images to a parallax for a suitable sense of depth, with which the eyes are less easily strained, corresponding to the distance between the viewer 9 and the display surface 61 and individual differences such as preference and a degree of fatigue of the viewer 9 and display a three-dimensional image.

The operation of the adjusted-image generating unit 5 is explained below.

FIGS. 15A and 15B are diagrams for explaining a relation among a parallax between the image input data for left eye Da1 and the image input data for right eye Db1, a parallax between image output data for left eye Da2 and image output data for right eye Db2, and projection amounts. FIG. 15A is a diagram for explaining a relation between the image input data for left eye Da1 and image input data for right eye Db1 and a projection amount. FIG. 15B is a diagram for explaining a relation between the image output data for left eye Da2 and image output data for right eye Db2 and a projection amount.

When the adjusted-image generating unit 5 determines that T3>S1b, the adjusted-image generating unit 5 outputs the image output data for left eye Da2 and the image output data for right eye Db2 obtained by horizontally shifting the image input data for left eye Da1 in the left direction and horizontally shifting the image input data for right eye Db1 in the right direction based on the parallax adjustment data T4. At this point, a parallax d2 is calculated by d2=d1−T4.

When a pixel P11 of the image input data for left eye Da1 and a pixel P1r of the image input data for right eye Db1 are assumed to be the same part of the same object, a parallax between the pixels P11 and P1r is d1 and, from the viewer, the pixels P11 and P1r are seen to be projected to a position F1.

When a pixel P21 of the image output data for left eye Da2 and a pixel P2r of the image output data for right eye Db2 are assumed to be the same part of the same object, a parallax between the pixels P21 and P2r is d2 and, from the viewer, the pixels P21 and P2r are seen to be projected to a position F2.

The image input data for left eye Da1 is horizontally shifted in the left direction and the image input data for right eye Db1 is horizontally shifted in the right direction, whereby the parallax d1 decreases to the parallax d2. Therefore, the projected position changes from F1 to F2 with respect to the decrease of the parallax.

The frame parallax data after correction T3 is calculated from the frame parallax data T2, which is the largest parallax data of a frame image. Therefore, the frame parallax data after correction T3 is the maximum parallax data of the frame image. The parallax adjustment data T4 is calculated based on the frame parallax data after correction T3 according to Formula (6). Therefore, when the parallax adjustment coefficient S1a is 1, the parallax adjustment data T4 is equal to the maximum parallax in a frame of attention. When the parallax adjustment coefficient S1a is smaller than 1, the parallax adjustment data T4 is smaller than the maximum parallax. When it is assumed that the parallax d1 shown in FIG. 15A is the maximum parallax calculated in the frame of attention, the maximum parallax d2 after adjustment shown in FIG. 15B is a value smaller than d1 when the parallax adjustment coefficient S1a is set smaller than 1. When the parallax adjustment coefficient S1a is set to 1 and the parallax adjustment threshold S1b is set to 0, a video is an image that is not projected and d2 is 0. Consequently, a maximum projection amount F2 of image output data after adjustment is adjusted to a position between the display surface 61 and the projected position F1.

The operation of the display unit 6 is explained below. The display unit 6 displays the image output data for left eye Da2 and the image output data for right eye Db2 separately on the left eye and the right eye of the viewer 9. Specifically, a display system can be a 3D display system employing a display that can display different images on the left eye and the right eye with an optical mechanism or can be a 3D display system employing dedicated eyeglasses that open and close shutters of lenses for the left eye and the right eye in synchronization with a display that alternately displays an image for left eye and an image for right eye.

Consequently, in this embodiment, it is possible to change a parallax between an input pair of images to a parallax for a suitable sense of depth, with which the eyes are less easily strained, corresponding to the distance between the viewer 9 and the display surface 61 and individual differences such as preference and a degree of fatigue of the viewer 9 and display a three-dimensional image.

In the first embodiment, the frame-parallax correcting unit 3 calculates an average of a plurality of the frame parallax data T2 before and after the frame of attention and outputs the average as the frame parallax data after correction T3. However, a median of the frame parallax data T2 before and after the frame of attention can be calculated and output as the frame parallax data after correction T3. A value obtained by correcting the frame parallax data T2 before and after the frame of attention can be calculated using other methods and output as the frame parallax data after correction T3.

### Second Embodiment

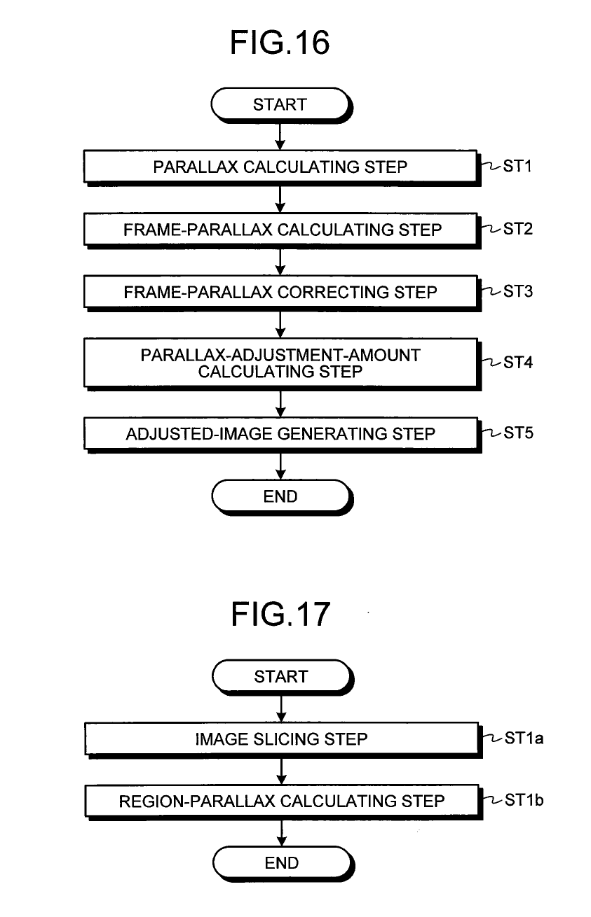

FIG. 16 is a diagram for explaining a flow of an image processing method for a three-dimensional image according to a second embodiment of the present invention. The image processing method according to the second embodiment includes a parallax calculating step ST1, a frame-parallax calculating step ST2, a frame-parallax correcting step ST3, a parallax-adjustment-amount calculating step ST4, and an adjusted-image generating step ST5.

The parallax calculating step ST1 includes an image slicing step ST1a and a region-parallax calculating step ST1b as shown in FIG. 17.

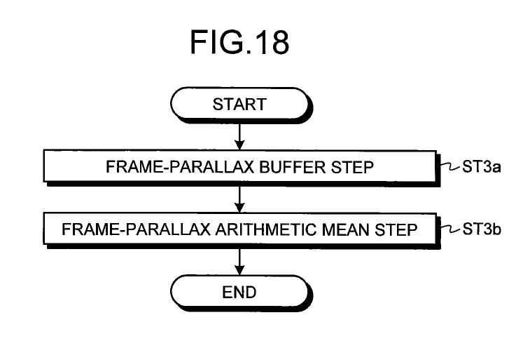

The frame-parallax correcting step ST3 includes a frame-parallax buffer step ST3a and a frame-parallax arithmetic mean step ST3b as shown in FIG. 18.

The operation of the image processing method according to the second embodiment is explained below.

First, at the parallax calculating step ST1, processing explained below is applied to the image input data for left eye Da1 and the image input data for right eye Db1.

At the image slicing step ST1a, the image input data for left eye Da1 is sectioned in an overlapping lattice shape having width W1 and height H1 and divided into x regions to create the divided image input data for left eye Da1(1), Da1(2), and Da1(3) to Da1(x). Similarly, the image input data for right eye Db1 is sectioned in a lattice shape having width W1 and height H1 to create the divided image input data for right eye Db1(1), Db1(2), and Db1(3) to Db1(x).

At the region-parallax calculating step ST1b, the parallax data T1(1) of the first region is calculated with respect to the image input data for left eye Da1(1) and the image input data for right eye Db1(1) for the first region using the phase limiting correlation method. Specifically, n at which the phase limiting correlation G_{ab}(n) is the maximum is calculated with respect to the image input data for left eye Da1(1) and the image input data for right eye Db1(1) and is set as the parallax data T1(1). The parallax data T1(2) to T1(x) are calculated with respect to the image input data for left eye Da1(2) to Da1(x) and the image input data for right eye Db1(2) to Db1(x) for the second to xth regions using the phase limiting correlation method. This operation is equivalent to the operation by the parallax calculating unit 1 in the first embodiment.

At the frame-parallax calculating step ST2, maximum parallax data among the parallax data T1(1) to the parallax data T1(x) is selected and set as the frame parallax data T2. This operation is equivalent to the operation by the frame-parallax calculating unit 2 in the first embodiment.

At the frame-parallax correcting step ST3, processing explained below is applied to the frame parallax data T2.

At frame-parallax buffer step ST3a, the temporally changing frame parallax data T2 is sequentially stored in a buffer storage device having a fixed capacity.

At the frame-parallax arithmetic mean step ST3b, an arithmetic mean of a plurality of the frame parallax data T2 of a frame of attention is calculated based on the frame parallax data T2 stored in the buffer region and the frame parallax data after correction T3 is calculated. This operation is equivalent to the operation by the frame-parallax correcting unit 13 in the first embodiment.

At the parallax-adjustment-amount calculating step ST4, based on the parallax adjustment coefficient S1a and the parallax adjustment threshold S1b set in advance, the parallax adjustment amount T4 is calculated from the frame parallax data after correction T3. At an hour when the frame parallax data after correction T3 is equal to or smaller than the parallax adjustment threshold S1b, the parallax adjustment data T4 is set to 0. Conversely, at an hour when the frame parallax data after correction T3 exceeds the parallax adjustment threshold S1b, a value obtained by multiplying an excess amount of the frame parallax data after correction T3 over the parallax adjustment threshold S1b with S1a is set as the parallax adjustment data T4. This operation is equivalent to the operation by the parallax-adjustment-amount calculating unit 4 in the first embodiment.

At the adjusted-image generating step ST5, based on the parallax adjustment data T4, the image output data for left eye Da2 and the image output data for right eye Db2 are calculated from the image input data for left eye Da1 and the image input data for right eye Db1. Specifically, the image input data for left eye Da1 is horizontally shifted to the left by T4/2 (half of the parallax adjustment data T4) and the image input data for right eye Db1 is horizontally shifted to the right by T4/2 (half of the parallax adjustment data T4), whereby the image output data for left eye Da2 and the image output data for right eye Db2 with a parallax reduced by T4 are generated. This operation is equivalent to the operation by the adjusted-image generating unit 5 in the first embodiment. The operation of the image processing method according to the second embodiment is as explained above.

In the image processing method configured as explained above, the image output data for left eye Da2 and the image output data for right eye Db2 with a parallax reduced by T4 are generated. Therefore, it is possible to change a parallax between an input pair of images to a parallax for a suitable sense of depth, with which the eyes are less easily strained, corresponding to the distance between the viewer and the display surface and individual differences such as preference and a degree of fatigue of the viewer and display a three-dimensional image.

According to the present invention, it is possible to improve accuracy of calculation of parallax of image input data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising a parallax calculating unit that receives input of a pair of image input data forming a three-dimensional video, calculates parallax amounts in respective regions obtained by dividing the pair of image input data into a plurality of regions, and outputs the parallax amounts as parallax data of the respective regions, wherein
the parallax calculating unit includes:
a correlation calculating unit that outputs correlation data and pre-selection parallax data of the respective regions;
a high-correlation-region extracting unit that determines a level of correlation among the correlation data of the regions and outputs high-correlation region data;
a denseness detecting unit that determines, based on the high-correlation region data, a level of denseness and outputs dense region data; and
a parallax selecting unit that outputs, based on the dense region data, the parallax data obtained by correcting the pre-selection parallax data.

2. The image processing apparatus according to claim 1, wherein the denseness detecting unit determines, with reference to a number of the regions present near the regions, whether the regions having the high-correlation region data determined as having high correlation are dense.

3. The image processing apparatus according to claim 1, wherein the parallax selecting unit corrects, according to weight average, the pre-selection parallax data of the regions determined as having high correlation and dense based on the dense region data.

4. The image processing apparatus according to claim 1, wherein the regions adjacent one another among the regions overlap one another

5. The image processing apparatus according to claim 1, wherein the high-correlation-region extracting unit outputs, as the high-correlation region data, a determination result obtained by comparing the correlation data of the regions with an average of the correlation data of the regions.

6. The image processing apparatus according to claim 1, further comprising:
a frame-parallax calculating unit that generates, based on the parallax data, frame parallax data and outputs the frame parallax data;
a frame-parallax correcting unit that outputs the frame parallax data of one frame as frame parallax data after correction obtained by correcting the frame parallax data with the frame parallax data of other frames;
a parallax-adjustment-amount calculating unit that outputs, based on parallax adjustment information created based on information indicating a state of viewing and the frame parallax data after correction, parallax adjustment data; and
an adjusted-image generating unit that generates a pair of image output data obtained by adjusting, based on the parallax adjustment data, a parallax amount of the pair of image input data.

7. The image processing apparatus according to claim 6, wherein the frame-parallax correcting unit calculates the frame parallax data after correction by calculating an average of the frame parallax data of one frame and the frame parallax data of other frames.

8. The image processing apparatus according to claim 6, wherein the parallax-adjustment-amount calculating unit generates the parallax adjustment data by multiplying the frame parallax data after correction with a parallax adjustment coefficient included in the parallax adjustment information.

9. The image processing apparatus according to claim 6, wherein the parallax-adjustment-amount calculating unit calculates the parallax adjustment data by multiplying the frame parallax data after correction larger than a parallax adjustment threshold included in the parallax adjustment information with the parallax adjustment coefficient.

10. The image processing apparatus according to claim 6, the adjusted-image generating unit moves, in a direction in which a parallax amount decreases by a half amount of the parallax adjustment data, respective image input data of the pair of image input data and generates a pair of image output data obtained by adjusting the parallax amount.

11. An image display apparatus comprising a parallax calculating unit that receives input of a pair of image input data forming a three-dimensional video, calculates parallax amounts in respective regions obtained by dividing the pair of image input data into a plurality of regions, and outputs the parallax amounts as parallax data of the respective regions, and
a display unit that displays a pair of image output data generated by the adjusted-image generating unit, wherein
the parallax calculating unit includes:
a correlation calculating unit that outputs correlation data and pre-selection parallax data of the respective regions;
a high-correlation-region extracting unit that determines a level of correlation among the correlation data of the regions and outputs high-correlation region data;
a denseness detecting unit that determines, based on the high-correlation region data, a level of denseness and outputs dense region data; and
a parallax selecting unit that outputs, based on the dense region data, the parallax data obtained by correcting the pre-selection parallax data.

12. An image processing method comprising:
receiving input of a pair of image input data forming a three-dimensional video, calculating parallax amounts in respective regions obtained by dividing the pair of image input data into a plurality of regions, and outputs the parallax amounts as a plurality of parallax data;
outputting correlation data and pre-selection parallax data of the respective regions;
determining a level of correlation among the correlation data of the regions and outputting high-correlation region data;
determining, based on the high-correlation region data, a level of denseness and outputting dense region data; and
outputting, based on the dense region data, the parallax data obtained by correcting the pre-selection parallax data.
